(19) United States
(12) Patent Application Publication
(10) Pub. No.: US 2006/0238506 A1
(43) Pub. Date: Oct. 26, 2006

(54) Double roller mouse structure

(75) Inventor: Oscar Yen, Taipei (TW)

Correspondence Address: BACON & THOMAS, PLLC, 625 SLATERS LANE, FOURTH FLOOR, ALEXANDRIA, VA, 22314, US

(73) Assignee: Chic Technology Corp., Taipei (TW)

(21) Appl. No.: 11/109,669

(22) Filed: Apr. 20, 2005

(51) Int. Cl. G09G 5/08

(52) U.S. Cl. 345/163

(57) ABSTRACT

The present invention relates to a double roller mouse structure, and more specifically to a computer mouse consisting of two roller structures mainly comprising a front roller and a left roller. The front roller is designed at the front part of the lower shell body of the mouse between the left key switch button and the right key switch button and is provided with three kinds of control switches for a forward, backward and pressed. The left roller is designed at the left part of the at lower shell body of the mouse and is perpendicular to the front roller and is provided with three kinds of control switches for a forward, backward and pressing movement. Hence, the present invention provides a newly designed structure wherein eight kinds of switch buttons can be controlled by the thumb, forefinger, middle finger and ring finger without moving the mouse.

### BACKGROUND OF THE INVENTION

The present invention relates to a double roller mouse structure, and more specifically to a computer mouse consisting of two roller structures.

Commonly used computer mice are generally provided with two switch buttons at the front section and a roller at the bottom and require a flat surface free from any obstacles and have to rely on the browser's indication for accurate directions.

Although a side roller or a switch button at the front roller are added to the improved structure of the above-mentioned computer mouse in order to comply with the requirements of the work, much improvement is needed as the problem of roller pollution, table surface and space limitations still exist.

If the drawbacks of the improved structure of the above-mentioned computer mouse is obviated and an advanced structure whereby the roller is eliminated, another substitute has to be found for the X and Y-axis direction control switches so as to meet the demands of personal computer users.

### SUMMARY OF INVENTION

The present invention relates to a double roller mouse structure still designed the left key switch button and the right key switch button at the front part of the mouse and a roller group is found between the left key and right key switch buttons in order to facilitate use of the middle finger for a forward, backward and pressing movement.

The present invention relates to a double roller mouse structure designed with a side roller which is provided forward direction, backward direction and pressing switch buttons, apart from cooperating with the front roller in substituting the original X axis direction and Y axis direction control switch designed at the roller ball located at the bottom; there is a three dimensional space, and save another space for special operation.

### DRAWINGS

FIG. 1 shows a part of the present invention;

FIG. 2 shows a decomposed plan of the group parts; and

FIG. 3 shows a plan of the roller switch action.

### DETAILED DESCRIPTION

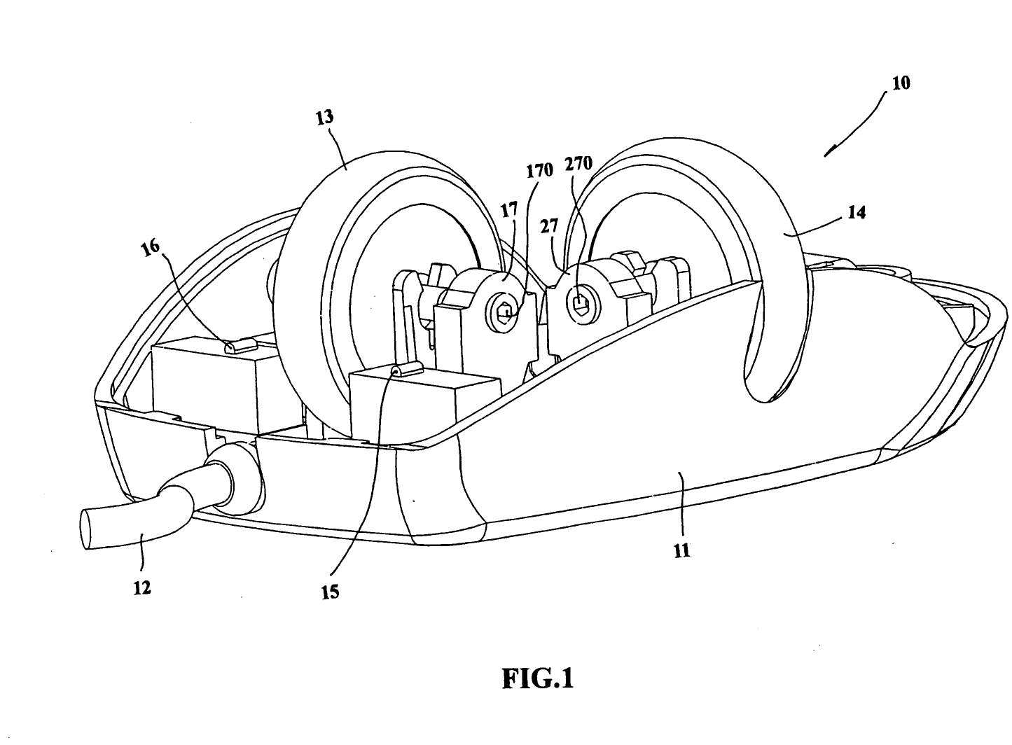

With reference to FIG. 1 showing a part of the present invention, the lower shell body 11 of said mouse 10 is designed with an extended signal line 12 at the front part to connect to the computer and the front roller 13 as well as the left roller 14 are slightly protruded out of the upper shell body (not shown in diagram) and lower shell body 11. The front roller 13 is situated between the left key switch button 15 and the right key switch button 16.

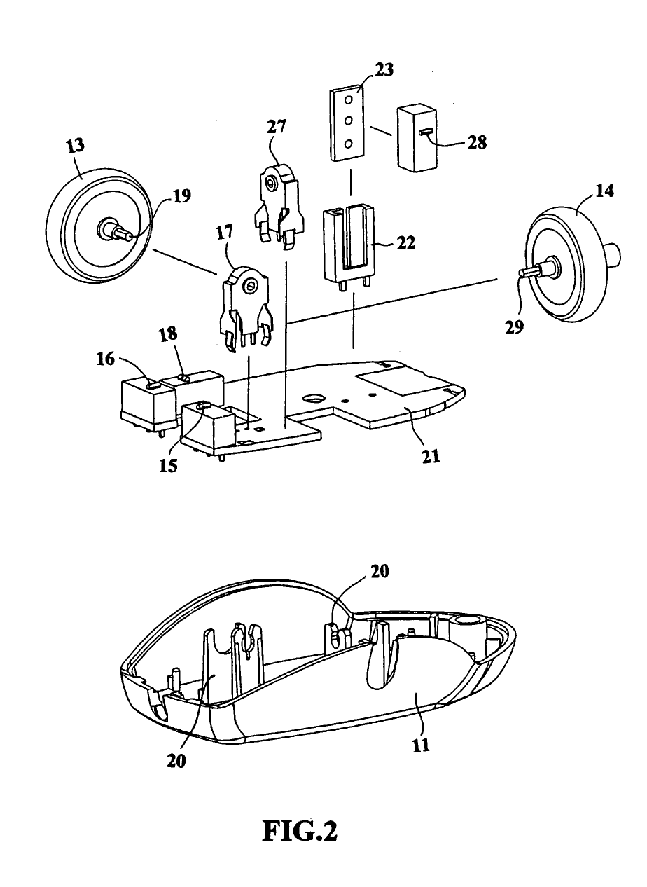

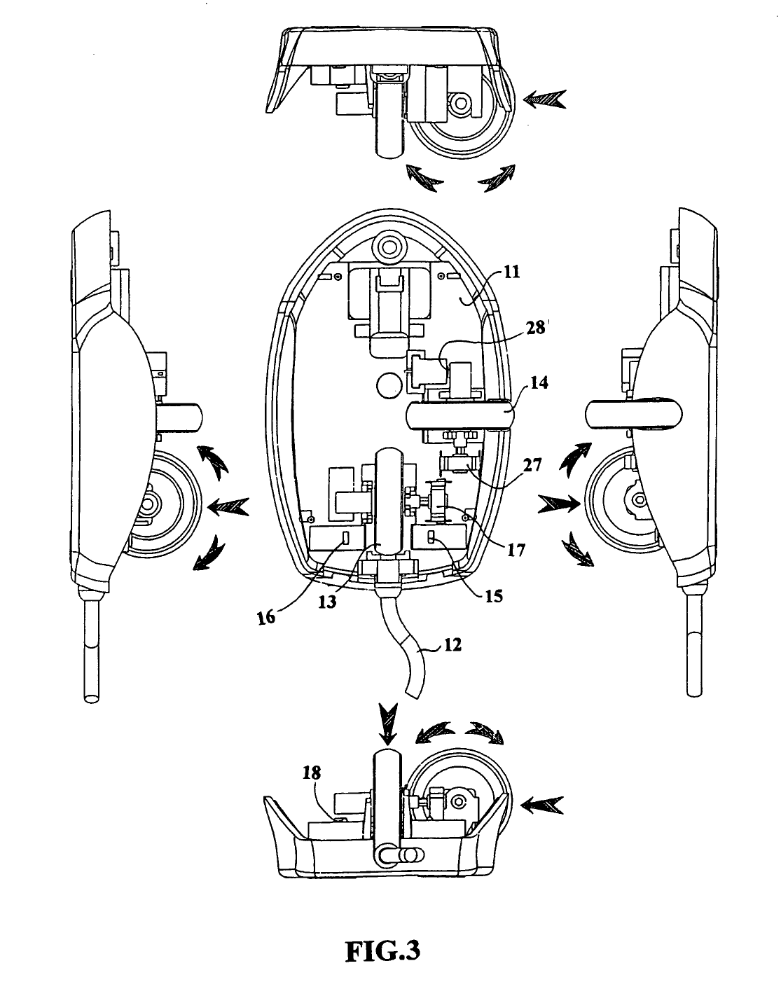

With further reference to FIG. 1, front roller 13 and left roller 14 are provided with a roller direction switch 17, 27 and a switch button 18, 28 (please refer to FIGS. 2 and 3). Roller direction switch 17 reflects all movements of multiple-sided axis 19 extending on each side and a forward or a backward direction is calculated by “0” or “1” and accurate signal direction is then emitted. The same or alike principle such as light-controlling assembly can also be applied to calculate accurate direction.

With reference to FIG. 2 showing a decomposed plan of the group parts, the lower shell body 11 of mouse 10 is mounted with several supporting axis 20 and all switch buttons including the left key switch button 15, right key switch button 16, switch button 18 of front roller 13, roller direction switch 17 of front roller 13 and switch button 28 of left roller 14 and roller direction switch 27 of left roller 14 are located on the same circuit plate 21. The front roller 13 and the left roller 14 are located on the supporting axis 20 and multiple-sided axis 19, 29 extend out from both sides and are inserted to axis holes 170, 270 of each roller direction switch 17,27. Further, since the left switch button 28 relates to the thumb switch button and for bearing its horizontal strength, a perpendicular frame stand 22 and a conducting plate 23 are specially designed so as to secure the switch button 28 to the lower shell body 11 and circuit plate 21.

With reference to FIG. 3 showing a plan of the roller switch action, we can understand from the top elevated view as well as the surrounding view that front roller 13 is designed with a forward rolling direction, a backward rolling direction and a perpendicular switch button 18. The left roller 14 is designed with a front (up) rolling direction and a backward (down) rolling direction and a switch button 28 with a horizontal direction and the left key switch button 15 and right key switch button 16 are not affected by the switch direction buttons. Hence, with the design of the present invention, the function of eight controlling switch buttons can be operated without sliding the mouse thus meeting the demands of the personal computer operation whereby there are no limitations to mouse operating space including table surface, obstacles and clean space. Further, although the present invention specified is mostly for right-handed users, the same principle structure can be applied for left-handed users without any exception.

I claim:

1. A double roller mouse structure mainly comprising a front roller and a left roller, wherein:
said front roller is designed at the front part of the lower shell body of the mouse between the left key switch button and the right key switch button and is provided with three kinds of control switches for a forward, backward and pressed;
said left roller is designed at the left part of the lower shell body of the mouse and is perpendicular to the front roller and is provided with three kinds of control switches for a forward, backward and pressed.

2. According to claim 1 of a double roller mouse structure, a signal line is extended at the front part of said lower shell body of the mouse for connection to the computer and the front roller as well as the left roller are slightly protruded at the edge of the shell body cover and the lower shell body.

3. According to claim 1 of a double roller mouse structure, the front roller and the left roller are provided with a roller direction switch and a switch button whereby the roller direction switch reflects the movement of the multiple-sided axis extending from each roller for accurate output rolling direction signal.

4. According to claim 2 of a double roller mouse structure, several supporting axis, all in one body, are designed in the lower shell body of the computer mouse and all switch buttons including the left key switch button, the right key switch button, front roller switch button, front roller direction switch, left roller switch button and left roller direction switch are located on the circuit plate.

5. According to claim 3 of a double roller mouse structure, said front roller and left roller are mounted on the supporting axis and a multiple-sided axis is extended on both sides and inserted to the axis holes of each roller direction switch; further, since the left switch button relates to the thumb switch button and for bearing its horizontal strength, a perpendicular frame stand and a conducting plate are specially designed, so as to secure the switch button to the lower shell body and the circuit plate.
